(19) United States
(12) Patent Application Publication
(10) Pub. No.: US 2025/0335338 A1
(43) Pub. Date: Oct. 30, 2025

(54) SYSTEMS AND METHODS FOR GENERATING TEST CASES FOR GRAPHICAL USER INTERFACE COMPONENTS

(71) Applicant: ServiceNow, Inc., Santa Clara, CA (US)

(72) Inventor: Kritika Goel, Hyderabad (IN)

(21) Appl. No.: 18/649,294

(22) Filed: Apr. 29, 2024

(51) Int. Cl. G06F 11/36

(52) U.S. Cl. CPC G06F 11/3684; G06F 11/3676; G06F 11/3696

(57) ABSTRACT

A method includes receiving a request to generate one or more test cases, wherein the request specifies a component of a graphical user interface (GUI). The method also includes identifying additional components associated with the component based on the request and a document object model (DOM) associated with the GUI, determining one or more properties associated with the specified component and each additional component of the additional components based on the DOM, generating one or more test cases for the component and each additional component of the additional components based on the one or more properties, and providing instructions to update the GUI. The instructions cause the GUI to indicate the one or more test cases.

### TECHNICAL FIELD

The present disclosure relates generally to development of a graphical user interface (GUI). Specifically, the present disclosure relates to generating test cases for components of a GUI.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

During development of a graphical user interface (GUI), the GUI may be tested to ensure reliability, functionality, and usability of the GUI. Developing and applying test cases for a GUI can be computationally expensive, as testing may include several iterations. A GUI may include numerous components, including windows, menus, labels, buttons, and so on, and different test cases may be formulated for each of these components. Further, a GUI component (e.g., parent component) may have one or more additional or associated components (e.g., child components) embedded within the GUI component that may be difficult to identify and test. Accordingly, improved techniques for generating test cases for a GUI are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Various embodiments disclosed herein are directed to a GUI test panel that generates and displays test cases that may be performed for one or more selected components of a GUI. The GUI test panel may identify any associated components (e.g., child components) of the selected components based on a Document Object Model (DOM) of the GUI and may generate and display test cases for the selected components and additional components. Specifically, the GUI test panel may analyze a DOM of the GUI to determine aspects of the selected components and associated components, such as component types (e.g., headers, charts), data types (e.g., integers, characters), inputs (e.g., entry fields), response types (e.g., on-click functionalities), and default contents to be displayed.

Based on the aspects of the selected components and/or child components present in the DOM, the GUI test panel may generate and display a name of the selected components and child components, an identification of the selected components and child components, and one or more test cases for each of the selected components and child components. In some embodiments, the GUI test panel may use a machine learning model trained on prior DOMs and/or test case data to analyze the DOM and generate and display test cases. The test cases may include steps that validate a behavior or presentation of a component, tips to complete the test case, and other relevant notes that may assist in testing or understanding the component. For example, a test case for a chart component may include instructions to validate the name of the chart, a note that the amount of data points in the chart is undefined, and a data schema of the chart (e.g., “data ID, data 0, x, timestamp, y, value y”).

The GUI test panel may be part of or used in conjunction with a GUI generation tool that facilitates development of the GUI. For example, the GUI test panel may be a tab, menu, plugin or the like included with the GUI generation tool, such that the GUI under test and the displayed test cases may be displayed simultaneously. This may allow for a more efficient testing process, as GUI components may be iteratively debugged and implemented from a single workspace or window. For example, components of a GUI may be selected by a drag-and-click operation and/or test case generation may be initiated based on input to a button or other user-selectable control. The GUI test panel may also include buttons, tabs, and the like that may facilitate input for additional functionalities, such as calculating and displaying a code coverage value based on GUI components and test cases.

In one embodiment, a method includes receiving a request to generate one or more test cases associated with a graphical user interface (GUI), the request specifying a component of the GUI. The method also includes determining, based on a document object model (DOM) associated with the GUI, one or more properties associated with the component and additional components of the GUI, generating, based on the one or more properties, one or more test cases for the component and for each of the additional components, and providing instructions to update the GUI, wherein the instructions cause the GUI to indicate the one or more test cases.

In another embodiment, a system, includes processing circuitry and a memory, accessible by the processing circuitry, and storing instructions that, when executed by the processing circuitry, cause the processing circuitry to perform operations including receiving a request to generate one or more test cases, wherein the request specifies a component of a graphical user interface (GUI) and identifying one or more additional components associated with the component based on the request and a document object model (DOM) associated with the GUI. The operations also include determining one or more properties associated with the specified component and each additional component of the one or more additional components based on the DOM and determining respective test case structures for the specified component and each additional component based on the one or more properties and a mapping of component types to test case structures. Additionally, the operations include generating one or more test cases for the component and each additional component of the one or more additional components based on the one or more properties and the respective test case structures providing instructions to update the GUI, wherein the instructions cause the GUI to indicate the one or more test cases.

In a further embodiment, a non-transitory, computer readable medium comprising instructions that, when executed by processing circuitry, cause the processing circuitry to perform operations including receiving a request to generate one or more test cases, wherein the request specifies a component of a graphical user interface (GUI) and identifying one or more additional components associated with the component based on the request and a document object model (DOM) associated with the GUI. The operations also include determining respective display data and a respective component type associated with the specified component and each additional component of the one or more additional components based on the DOM and determining a respective test case structure for each of the specified component and the one or more additional components based on the respective component type of each of the specified component and the one or more additional components, wherein each respective test case structure comprises an instruction associated with the respective component type. Additionally, the operations include combining each respective test case structure with the respective display data to form one or more test cases for the component and each additional component of the one or more additional components and providing instructions to update the GUI, wherein the instructions cause the GUI to indicate the one or more test cases.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present techniques may operate;

FIG. 2 is a schematic diagram of an embodiment of a multi-instance cloud architecture in which embodiments of the present techniques may operate;

FIG. 3 is a block diagram of a computing device utilized in a computing system that may be present in FIG. 1 or 2, in accordance with aspects of the present techniques;

FIG. 4 is a block diagram illustrating a virtual server that supports and enables a client instance, in accordance with aspects of the present disclosure;

FIG. 5 is a screenshot of a workspace for testing a GUI in which a DOM of the GUI is displayed, in accordance with aspects of the present disclosure;

FIG. 6 is a screenshot of the workspace of FIG. 5 in which one or more test cases for testing components of the GUI are displayed, in accordance with aspects of the present disclosure;

FIG. 7 is a screenshot of the workspace of FIG. 5 in which additional test cases for testing additional components of the GUI are displayed, in accordance with aspects of the present disclosure; and

FIG. 8 is a flow chart of a process for generating and displaying test cases for one or more components of a GUI, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As mentioned, a GUI may include numerous components, including windows, menus, labels, buttons, and so on, and different test cases may be formulated for each of these components. As used herein, a test case for a component of a GUI may be understood to mean a set of steps and/or criteria that may be used to verify and evaluate aspects of the component. Test cases may be applied to evaluate responses of each GUI component to positive inputs (e.g., expected scenarios), negative inputs (e.g., unexpected scenarios), boundary conditions, and so on to ensure proper functionality. A GUI component may be tested for responsiveness, deviations from expected behavior, issues encountered, and so on, and results may be recorded to ensure comprehensive testing. For each test case, GUI inputs (e.g., mouse clicks or keystrokes), procedures of a test case, expected results of the test case, actual results of the test case, and other factors may be considered. With so many considerations, it may be difficult to determine which components of a GUI have been comprehensively tested by developed test cases, which may lead to omissions of necessary test procedures.

Various embodiments disclosed herein are directed to a GUI test case generation tool that generates and displays test cases that may be performed for one or more selected components of a GUI. The GUI test case generation tool may identify any associated components (e.g., child components) of the selected components based on a Document Object Model (DOM) of the GUI and may generate and display test cases for the selected components and additional components. Specifically, the GUI test case generation tool may analyze a DOM of the GUI to determine aspects of the selected components and associated components, such as component types (e.g., headers, charts), data types (e.g., integers, characters), inputs (e.g., entry fields), response types (e.g., on-click functionalities), and default contents to be displayed.

Based on the aspects of the selected components and/or child components present in the DOM, the GUI test case generation tool may generate and display a name of the selected components and child components, an identification of the selected components and child components, and one or more test cases for each of the selected components and child components. In some embodiments, the GUI test case generation tool may use a database or library of test case structures and/or a machine learning model trained on prior DOMs and/or test case data to analyze the DOM and generate and display test cases. The test cases may include steps that validate a behavior or presentation of a component, tips to complete the test case, and other relevant notes that may assist in testing or understanding the component. For example, a test case for a chart component may include instructions to validate the name of the chart, a note that the amount of data points in the chart is undefined, and a data schema of the chart (e.g., “data ID, data 0, x, timestamp, y, value y”).

The GUI test case generation tool may be part of or used in conjunction with a GUI generation tool that facilitates development of the GUI. For example, the GUI test case generation tool may be a tab, menu, plugin or the like included with the GUI generation tool, such that the GUI under test and the displayed test cases may be displayed simultaneously. This may allow for a more efficient testing process, as GUI components may be iteratively debugged and implemented from a single workspace or window. For example, components of a GUI may be selected by a drag-and-click operation and/or test case generation may be initiated based on input to a button. A workspace of the GUI test case generation tool may also include buttons, tabs, and the like that may facilitate input for additional functionalities, such as calculating and displaying a code coverage value based on GUI components and test cases. In previously available systems, test cases were manually developed for each component of a GUI. Using manually developed test cases results in an error-prone, time-consuming, and computationally expensive process.

The techniques described herein provide improved performance in testing a GUI and components therein. For example, identifying associated components and determining properties of the components based on the DOM allows for associated components to be properly accounted for during testing. Likewise, automatically generating test cases for components based on the DOM allows for comprehensive testing of the components, as properties of the components present in the DOM may be properly accounted for in generated test cases.

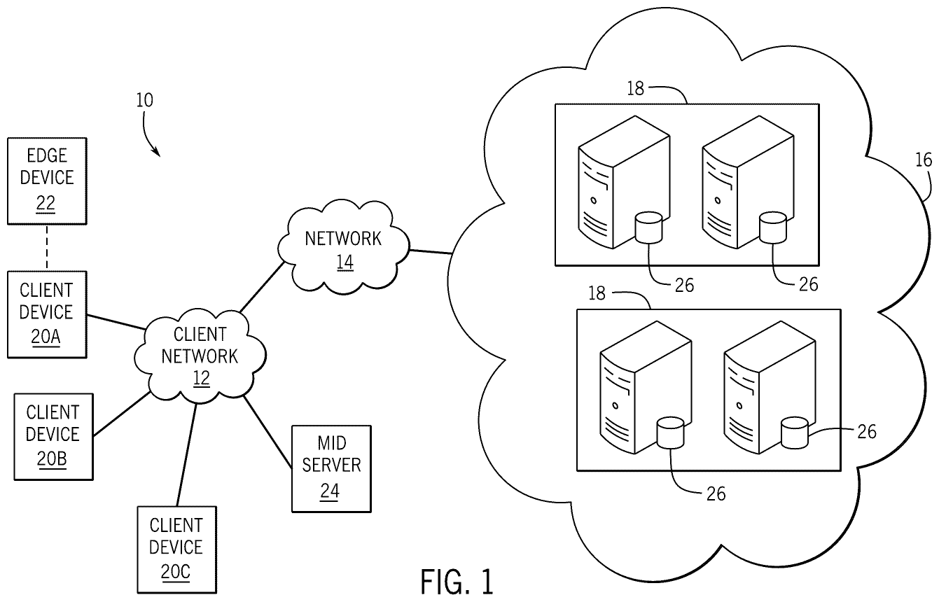

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is connected to one or more client devices 20 (e.g., client devices 20A, 20B, and 20C) so that the client devices 20 are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, server, or software-implemented agent, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to as application nodes, application servers, virtual server instances, application instances, or application server instances), where one or more virtual servers 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

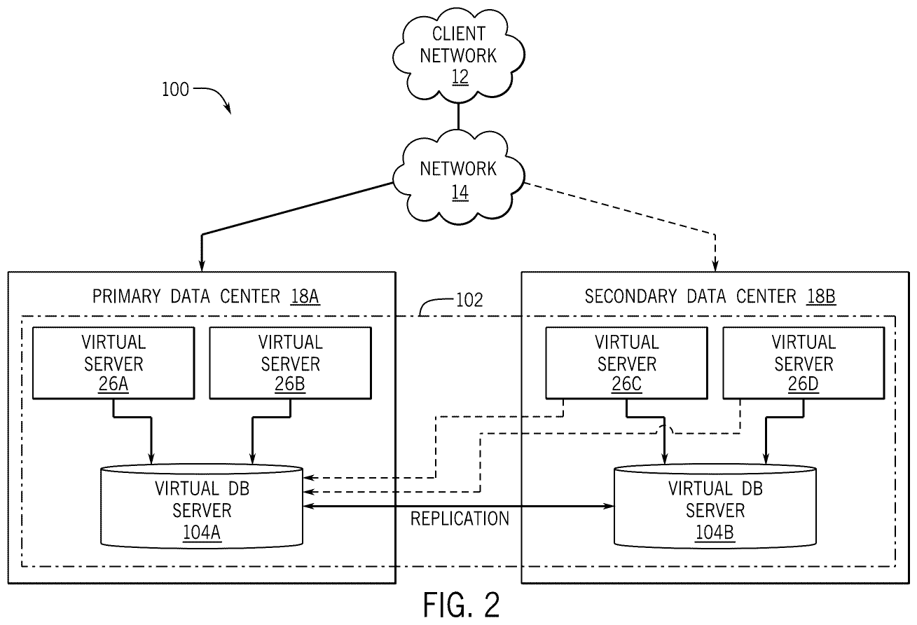

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

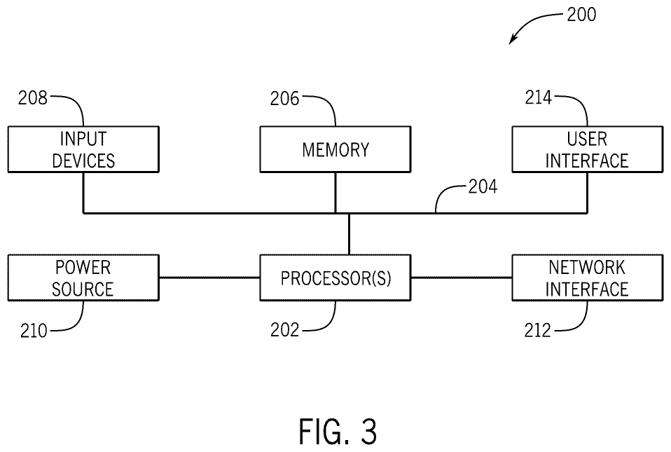

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing system 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

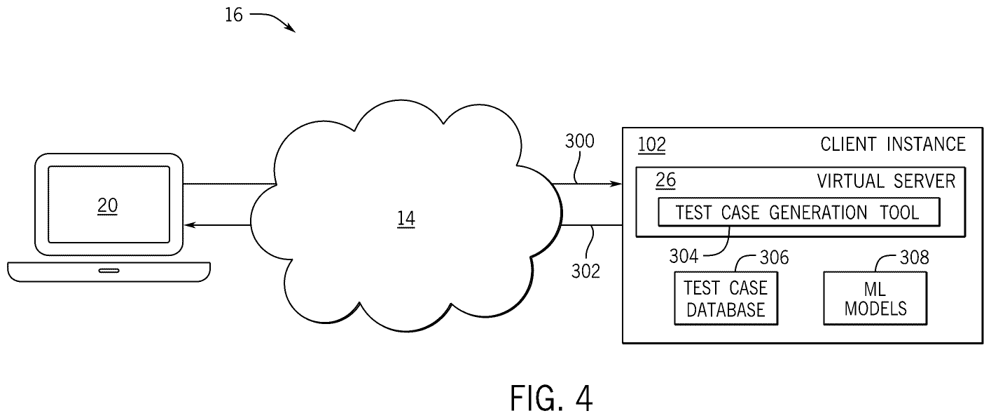

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface and/or a development environment for developing and testing the user interface, to network applications executing within the client instance 102 (e.g., via a web browser or a native application running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 300, to which the client instance 102 may respond with outputs 302. In the embodiment shown in shown in FIG. 4, the virtual server 26 of the client instance 120 may run a test case generation tool 304, which may be a software application defined by code, accessible via a native application or web browser of the client device 20. Accordingly, the inputs 300 may include inputs requesting one or more test cases for components of a GUI, providing a DOM, specifying a component of the GUI, or requesting a code coverage value of test cases of the GUI. Correspondingly, the outputs 302 may include requested test cases (e.g., instructions to update a GUI to include the requested test cases), responses to inputs 300, and so forth. For example, one or more test cases may be requested for a GUI to simulate a scenario that the GUI may experience while in operation. Accordingly, the one or more test cases may provide instructions to ensure that the GUI responds to the scenario as intended.

The test case generation tool 304 may utilize a test case database 308 and/or one or more machine learning (ML) models 308, each of which may be stored within the client instance or otherwise made accessible to the client instance, to generate some or all of the outputs 302. The test case database 308 may store test case structures (e.g., natural language structures) for test cases that may be used selectively by the test case generation tool 304 to generate test cases for components of a GUI. For example, the test case database may store portions of steps that validate a behavior or presentation of a GUI component, tips to complete a test case, or other relevant notes that may assist in testing or understanding a GUI component. The test case generation tool 304 may utilize certain test case structures stored in the test case database 306 to generate a test case for a component based on, for example, a type, a data type, inputs, response types, or default contents of a component. Additionally or alternatively, the test case generation tool 304 may use a library of test case structures to generate the one or more test cases, and the library may be stored on a memory device accessible by the test case generation tool.

The one or more ML models 308 may be trained on previously tested DOMs and/or test case data, and may produce one or more natural language outputs corresponding to one or more test cases for components of a GUI. In some embodiments, the one or more ML models 308 may include one or more large language models (LLMs). As used herein, a large language model (LLMs) is a probabilistic model of a natural language used for general-purpose language generation. LLMs typically include one or more artificial neural networks having a transformer-base architecture. LLMs learn statistical relationships from text documents through training processes that may be supervised, semi-supervised, or self-supervised. During training, LLMs may learn syntax, semantics, and/or ontology. LLMs, when used for text generation, receive an input text and iteratively predict the next word or token. It should be understood that the client instance 102 shown in FIG. 4 may be utilized by the client device 20 for other tasks associated with testing a GUI, as well as tasks beyond the scope of GUI testing and development.

Traditionally, developing and applying test cases for a GUI can be computationally expensive, as testing may include several iterations. For example, test cases may be applied to evaluate responses of each GUI component to positive inputs (e.g., expected scenarios), negative inputs (e.g., unexpected scenarios), boundary conditions, and so on to ensure proper functionality. A GUI component may be tested for responsiveness, deviations from expected behavior, issues encountered, and so on, and results may be recorded to ensure comprehensive testing. For each test case, GUI inputs (e.g., mouse clicks or keystrokes), procedures of a test case, expected results of the test case, actual results of the test case, and other factors may be considered. With so many considerations, it may be difficult and/or computationally expensive to determine which components of a GUI have been comprehensively tested by developed test cases.

The presently disclosed test case generation tool 304 receives a DOM of a GUI and an indication of a specified component of the GUI and automatically generates test cases for the specified component and associated components. A Document Object Model (DOM), as used herein, may include a structural interface of a GUI that represents the GUI and the graphical components therein in a programming language. In particular, a DOM may represent a GUI as a tree-like structure including nodes that correspond to components of the GUI, which may include windows, menus, labels, buttons, and so on. The test case generation tool may determine associated components (e.g., child components) based on the structure of the DOM, and may determine aspects of the specified component and associated components, such as component names, component identifiers, component types, the data types, inputs, response types, and so on based on contents of the DOM. As used herein, a component or graphical component of a GUI may include buttons, text fields, labels, checkboxes, dropdown lists, menus, sliders, tabs, dialog boxes, icons, labels, or other visual elements of the GUI, and a “child component”, “associated component”, or “additional component” may refer to a component that is contained within or otherwise associated with a parent component (e.g., a specified component).

The test case generation tool 304 may use the test case database 306 and/or the one or more ML models to automatically generate test cases for the specified component and the associated components based on aspects (e.g., properties) of the components present in the DOM. In one example, the test case generation tool 304 may combine a test case structure stored in the test case database 306 and aspects of a component to form a test case for the component. In another example, the test case generation tool 304 may provide aspects of a component present in the DOM to the one or more ML models, and the one or more ML models may produce a test case for the component as output to the test case generation tool 304. The test case generation tool 304 may cause the GUI to display a component name, a component identifier, and one or more steps of a generated test case corresponding to each of the specified component and associated components in a workspace. For example, the test case generation tool 304 may send, as outputs 302, instructions to the client device 20 to update a workspace displayed by the client device 20 to display a component name, component identifier, and test case for each of the specified component and associated components.

As mentioned, the component name, component identifier, and test case for each of the specified component and associated components of the updated GUI may be part of, or used in conjunction with, a GUI generation tool that facilitates development of the GUI. For example, the updated GUI may be a tab, menu, plugin or the like included with the GUI generation tool in a common workspace, such that the GUI under test and the displayed test cases may be displayed simultaneously. This may allow for a more efficient testing process, as GUI components may be iteratively debugged and implemented from a single workspace or window. For example, components of a GUI may be selected by a drag-and-click operation and/or test case generation may be initiated based on input to a button. The workspace may also include buttons, tabs, and the like that may facilitate input for additional functionalities of the test case generation tool, such as calculating and displaying a code coverage value based on GUI components and test cases.

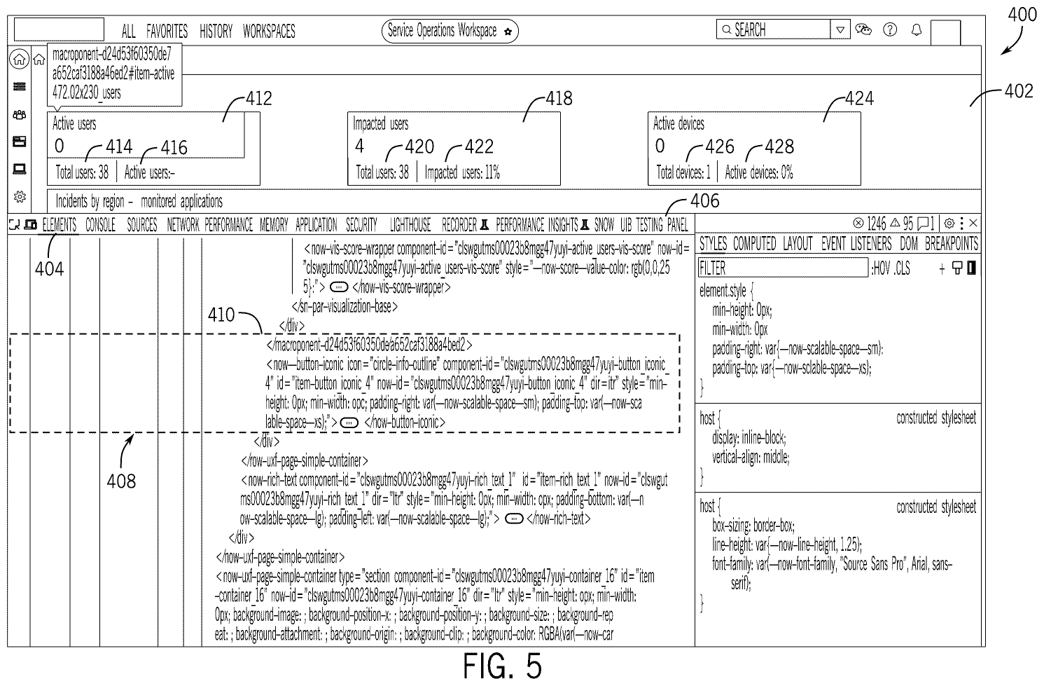

With the foregoing in mind, FIGS. 5-7 represent example screenshots of a workspace that may display a GUI and test cases generated for components of the GUI. It should be understood, however, that the screenshots depicted in FIGS. 5-7 are merely examples and that embodiments having different workspaces, and GUIs having different components, are envisaged and are encompassed by the present description. Specifically, FIG. 5 is a screenshot of a workspace 400 displaying a DOM of a GUI 402. As illustrated, the workspace 400 includes multiple tabs that may be selected including a first tab 404 and a second tab 406. When the first tab 404 is selected, the workspace 400 includes a DOM 408 of the GUI 402. The DOM 408 of the GUI 402 may be generated upon selection of the first tab 404 or updated in response to changes to the GUI 402. For example, in response to selection of the first tab 404, a test case generation tool may parse a markup language representation (e.g., a HyperText Markup Language (HTML) Extensible Markup Language (XML) representation) of the GUI 402 for content and structural aspects of the GUI 402, may create nodes corresponding to one or more components based on the markup language, may construct a tree structure of the nodes, and may link parent nodes of parent components to child nodes of child components. Each node may include information related to properties, method, characteristics, and behaviors of a component. When the DOM 408 has been generated, the test case generation tool may update the workspace 400 to display the DOM 408.

Portions of the DOM 408 may correspond to one or more elements of the GUI 402. In the illustrated example, a portion 410 of the DOM 408 corresponds to a first component 412, here illustrated as a header element that includes an indication of a number of active users. Additionally or alternatively, components of the GUI 402 may include, for example, a block of text, a component for receiving text input, an image, an icon, an interactive visual component, a widget, an advertisement, a hyperlink, a nested list or tree, a tab, a slider, a toolbar, a menu, a scrollbar, a label, and/or a checkbox. The first component 412 may contain child components 414 and 416, which may be associated with the first component 412 by a structural relationship present in the DOM 408. As illustrated, the portion 410 of the DOM 408 corresponding to the first component 412 includes aspects of the component 412, such as a type of button icon, a component identifier, directions, formatting information, and so on, which is presented in a programming language of the DOM 408. As may be appreciated, different portions of the DOM 408 may include aspects of a second component 418, a third component 424, and child components 420, 422, 426, 428. Further, the DOM 408 may link the child components 420 and 422 to the second component 418 and may link the child components 426 and 428 to the third component 424.

As may be appreciated, it may be difficult to determine which portion of the DOM 408 corresponds to a component of the GUI 402, especially for complex GUIs with numerous components. As such, in some embodiments, the workspace 400 may indicate one or more portions of the DOM 408 that correspond to a specified component of the GUI 402. In the illustrated embodiment, the component 412 may be specified by a drag-and-click operation and, in response, the workspace 400 may update to include and highlight the portion 410 corresponding to the component 412. Likewise, the portion 410 may be indicated by a click or hovering operation, and the workspace 400 may update to highlight the component 412 of the GUI 402.

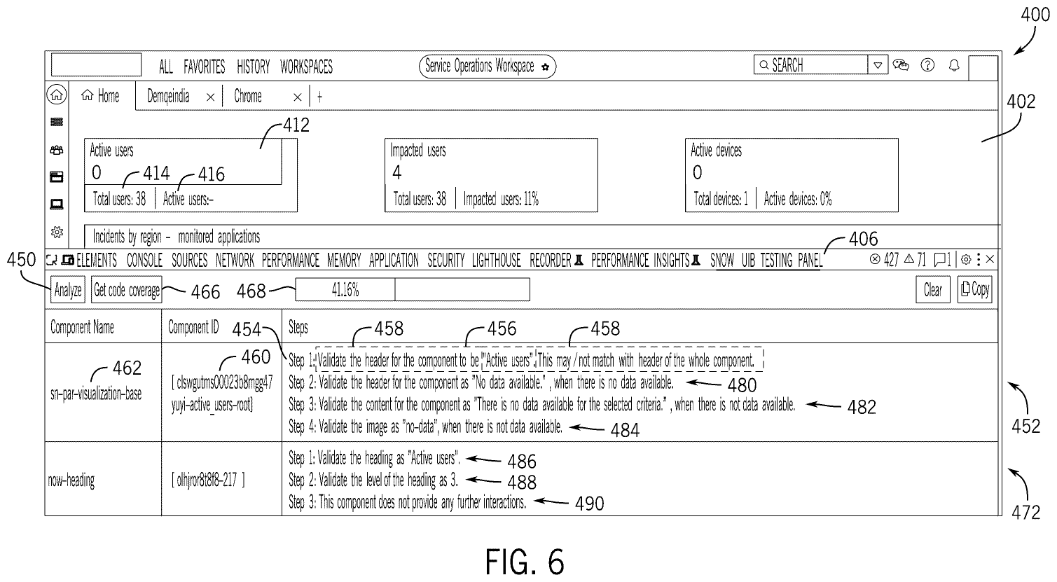

When the second tab 406 is selected, the workspace 400 includes graphical elements for test case generation and display. FIG. 6 shows a screenshot of the workspace 400 that displays a first test case 452 and a second test case 472 for components of the GUI 402 when the second tab 406 is selected, along with buttons and other visual elements that may aid in a testing process of the GUI. In the embodiment illustrated in FIG. 6, the workspace 400 includes a button 450 that, when selected, may cause a test case generation tool to generate one or more test cases for a specified component and components associated with the specified component. Further, each test case may be displayed with a name and identifier of the component of the test case in the workspace 400.

A component may be specified and/or selected via the workspace 400 by, for example, a click or drag-and-click operation on the GUI 402, a selection of a portion of the DOM 408 corresponding to a component, or other suitable input method. Further, if no component is specified, the specified component may default to a parent component (e.g., host element) of the GUI 402, which may contain each component of the GUI and which may be specified in the DOM 408. In the illustrated embodiment, the first component 412 is selected as the specified component, and the test case generation tool may determine one or more associated components based on the DOM 408. For example, the test case generation tool may parse the DOM 408 for structural relationships associated with the first component 412 and may determine that the child component 414 and the child component 416 are child components of the first component 412. The test case generation tool may, for example, determine that the first component 412 is a header component, and that the header component contains identifiers corresponding to the child component 414 and the child component 416. Further, the test case generation tool may continue to parse the DOM 408 for components associated with each of the child component 414 and the child component 416, such as additional child components of the child component 412 and/or the child component 414. In other words, the test case generation tool may determine a complete hierarchy of components associated with the first component 412, and may generate test cases for each component in the hierarchy.

To generate the test cases for each of the specified component and the one or more associated components, a test case generation tool may use test case structures of a test case database and/or one or more ML models. The test case database may include corresponding test case structures for various component types, and each corresponding test case structure may include an instruction in natural language associated with a component type and one or more inputs fields. That is, the test case database may map component types to corresponding test case structures. The test case generation tool may replace each of the one or more input fields with data (e.g., display data) from a portion of the DOM corresponding to a component to form a test case. As such, the test case generation may combine a test case structure with data from the DOM to form one or more test cases.

In the illustrated embodiment, the test case generation tool may determine, based on the DOM 408, that the first component 412 includes a header component, and may select a corresponding test case structure from a test case database. The test case generation tool may combine the selected test case structure and data in the portion 410 of the DOM 408 corresponding to the first component 412 to form one or more steps of a test case for the first component 412. As illustrated, the first test case 452 may include a first step 454. In some embodiments, the first step 454 may include a test case structure 458 from the test case database and data 456 from the portion 410 of the DOM. As such, the test case structure 458 and the data 456 may be combined to form the first step 454 of the first test case 452. As illustrated, the first test case 452 also includes a second step 480 to validate the header of the first component 412 when there is no data available, a third step 482 to validate a content of the first component 412 when there is no data available, and a fourth step 484 to validate an image of the first component 412 when there is no data available. In another example, the DOM 408 or the portion 410 of the DOM 408 may be provided to one or more ML models, and the one or more ML models may provide, as output, the test case structure of the first step 454. In any case, the test case generation tool may generate one or more test cases, each of which contain one or more steps, for each of the specified component and the component determined to be associated with the specified component.

A test case of a component may be displayed alongside identifying information of the component. In the illustrated example, the first test case of the first component 412 may be displayed with a first component name 462 and a first component identifier 460. Further, in some embodiments, the first component identifier 460 may include a button or hover function that, when activated, causes the workspace 400 to update to include an indication (e.g., highlighted indication) of the first component 412 on the GUI 402 such that the first component identifier 460 and the first component are visually associated. Additionally, each displayed test case may correspond to a specified component or a component that is associated with the specified component. In the illustrated embodiment, the first test case 452 corresponds to the first component 412, and the second test case 472 corresponds to a child component of the first component, such as the child component 414 or the child component 416.

The workspace 400 may include additional functionality that may aid in a testing process of the GUI 402. For example, the workspace 400 may present a code coverage indication 468 in response to a code coverage button 466 being selected. The code coverage indication 468 may include a percentage value or other value that indicates a portion of the GUI 402 that has been accounted for (e.g., covered) by the test cases displayed in the workspace 400 or generated by a test case generation tool. For example, a test case generation tool may determine, based on the DOM 408, a total quantity of components present in the GUI 402. The test case generation tool may also determine a number of components of the GUI 402 that test cases have been generated for by, for example, counting the identifiers associated with the displayed test cases. The workspace may then display the code coverage indication 468 based on the total components and the number of components that test cases have been generated for.

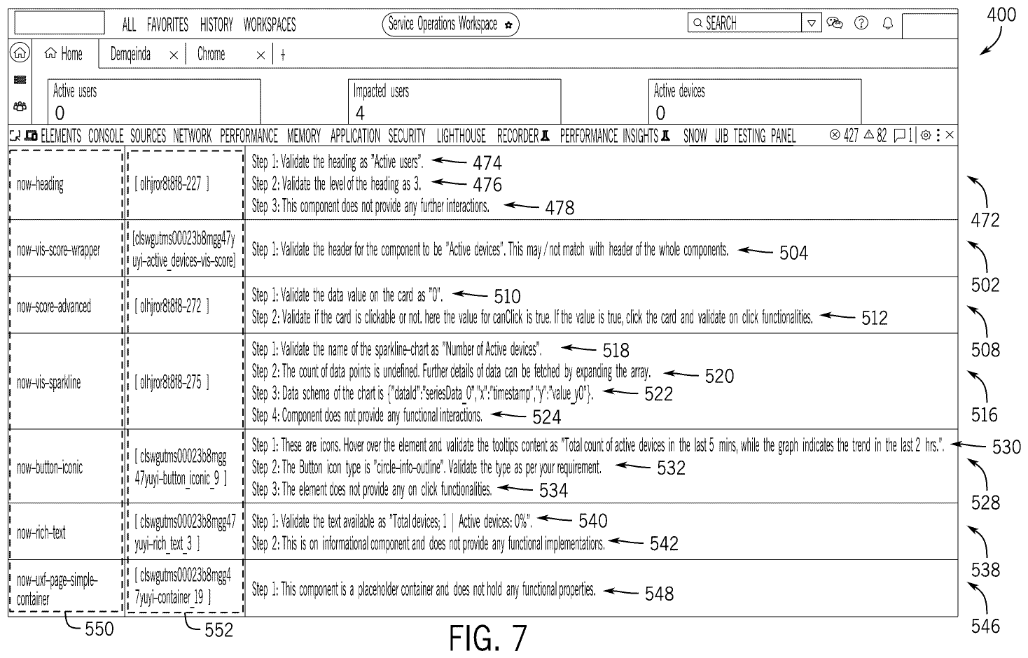

As may be appreciated, aspects of each test case for a component (e.g., a specified component or an associated component) may vary based on qualities of the component, such as a component type, data type, input response behavior, or response type of the component, which may be determined based on a portion of a DOM corresponding to the component. Additionally, each test case for a component may include relevant information that may assist in testing or understanding the component, such as steps that validate a behavior or presentation of the component, tips to complete the test case, and so on, that may be generated based on the DOM, a test case database, and/or one or more ML models. FIG. 7 shows a screenshot of the workspace 400 including example test cases, each example test case having varying steps and relevant information that may assist in completing the test case. The test cases illustrated in FIG. 7 may be generated and displayed in the workspace 400 with the test cases illustrated in FIG. 6 and/or may be viewable by, for example, a scrolling operation in the workspace 400. Further, the test cases illustrated in FIG. 7 may correspond to components within a common hierarchy of components as determined based on the DOM 408 of the GUI 402. For example, the illustrated test cases may each be child components of the first component 412.

As illustrated, the test case 472, which may correspond to a heading child component, includes a first step 474 to validate a heading as “Active users”, and a second step 476 to validate the level of the heading as “3”. Additionally, the test case 472 includes relevant information, here illustrated as a tip 478, which advises a user that the component corresponding to the test case 472 does not provide any further interactions. It should be noted that while the relevant information included in the test case 472 is illustrated as a third “step”, the relevant information may alternatively be indicated with other words, icons, and the like, such as an exclamation point icon or a textual indicator of “Hint:” or “Note:”. As may be appreciated, in some embodiments, the indicator associated with relevant information and/or steps to a test case may be determined based on a test case structure stored in a test case database or based on an output of an ML model.

In some examples, relevant information may be included with a step of a test case. The test case 502, which may correspond to a wrapper child component, includes a step 504 to validate a header for the component to be “Active devices”. Additionally, the step 504 includes the context that the header may not match the header of the whole component. That is, the header of the child component may differ from a header of the parent component. As such, a user may be alerted to such a potential difference when testing the component.

Some test cases may include a combination of instructions and relevant information to aid in completing the test case. Further, some test cases may include conditional instructions. The test case 508, which may correspond to a card child component, includes a first step 510 to validate the data value on the card as “0”. The test case 508 also includes a second step 512 to validate if the card is clickable or not, along with information that that a canClick value is true. Additionally, the second step 512 includes conditional instructions to click the card and validate functionalities of the component if the value is true.

A test case 516, which may correspond to a sparkline chart child component, may include a first step 518 to validate the name of the sparkline chart as certain text, here illustrated as “Number of Active devices,” which may be based on data parsed for a portion of the DOM 408 corresponding to the sparkline child component, as described herein. The test case 516 may also include first relevant information 520 indicating that the count of data points for the sparkline chart is undefined and that further details of data can be fetched by expanding the array. Additionally, the test case 516 includes second relevant information 522 indicating a data schema of the chart, and the illustrated data schema may also be based on data parsed for a portion of the DOM 408 corresponding to the sparkline child component. Finally, the test case 516 includes third relevant information 524 indicating that the sparkline chart child component does not provide any functional interactions (e.g., on-click functionalities).

Further, a test case 528 may correspond to an icon child component, and may include a first step 530, a second step 532, and relevant information 534. As illustrated, the first step 530 includes an indication of the component type and instructions to hover over the element and validate a content of the component, the second step 532 includes an indication of a further component type specification and instructions to validate the type as per user requirements, and the relevant information 534 includes an indication that the component does not provide any on-click functionalities. Additionally, a test case 538, which may correspond to a text field child component, may include a step 540 to validate the text as including certain data and relevant information 542 indicating that the text field child component is an informational component and does not provide any functional implementations. Finally, a test case 546, which may correspond to a placeholder container child component, may include relevant information 548 that the component is a placeholder container that does not hold any functional properties.

As mentioned, each of the illustrated test cases 472, 502, 508, 516, 528, 538 may correspond to a component of the GUI 402, which may include a specified component or a component associated with the specified component, such as a child component of the specified component. In the illustrated embodiment, each test case may be displayed with (e.g., in a row with, adjacent to) a component name of one or more component names 550 and a component identifier of one or more component identifiers 552 in the workspace 400.

Each component name 550 may identify a component according to, for example, a component type or other recognizable aspect of the component, which may allow a user to recognize a test case as corresponding to a particular component of the GUI 402. In the illustrated example, the test case 516 for a sparkline chart component may have a “now-vis-sparkline” component name by which a user may associated the test case 516 and the sparkline chart component.

Each of the component identifiers 552 may associate a corresponding test case to, for example, a unique identification value of a component of the GUI 402, which may be determined based on the DOM. For example, when generating the test case 516 for a sparkline chart component, a test case generation tool may parse a portion of the DOM 408 corresponding to the sparkline chart component and may determine the unique identifier for the test case 516 as illustrated. Further, each component identifier 552 may indicate a component of the GUI corresponding to a test case in response to a user input. For example, in response to a user hovering over a unique identifier for an icon component corresponding to the test case 528, the corresponding icon component may be indicated as a highlighted portion in the GUI 402. This may aid in an understanding of the GUI 402 by visually associating each test case and a corresponding component.

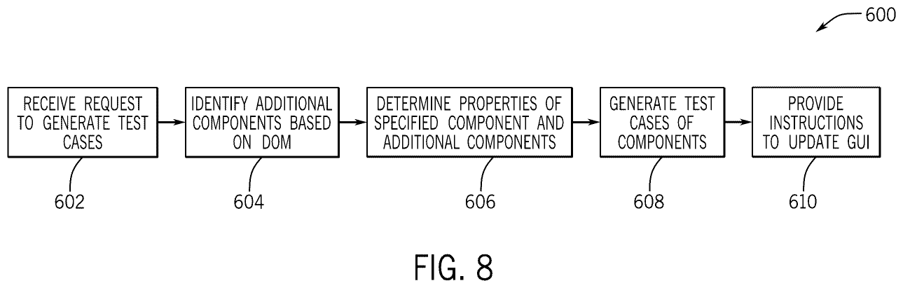

FIG. 8 is a flowchart of a process 600 for generating and displaying test cases for one or more components of a GUI, such as the GUI 402 of FIG. 5. The process 600 may be performed by the client instance 102, the virtual server 26, the client device 20, a computing device or controller disclosed above with reference to FIG. 1 or any other suitable computing device(s) or controller(s). Furthermore, the blocks of the process 680 may be performed in the order disclosed herein or in any suitable order. For example, certain blocks of the process may be performed concurrently. In addition, in certain embodiments, at least one of the blocks of the process 600 may be omitted.

The process 600 may begin, in block 602, with receiving a request to generate test cases for one or more components of a GUI, such as the GUI 402 of FIG. 5. As described herein, the request may specify a component (e.g., a selected component) of the GUI, which may be selected by user input, such as a click, drag-and-click, or keystroke. In some embodiments, the request to generate test cases for one or more components of a GUI may include a DOM of the GUI or certain portions of the DOM of the GUI.

In block 604, the process 600 may identify associated components based on the DOM of the GUI. The associated components may include components that are associated with the specified component, such as child components of the specified component. In particular, the DOM may include structural relationships that define a tree-like structure of components of a GUI, and the tree-like structure may be parsed (e.g., analyzed) to identify components associated with the specified component. The DOM may be parsed via a suitable algorithm or search technique, such as breadth-first search (BFS), depth-first search (DFS), or the like to identify associated components. Further, the test case generation tool may determine a complete hierarchy of components associated with the specified component by recursively parsing for components associated with identified associated components. Block 604 may also include identifying portions of the DOM corresponding to the identified associated components.

In some embodiments, the request to generate test cases for one or more components of the GUI may not include a specified component if, for example, no specified component is selected by a user. In such embodiments, the process 600 may determine the specified component as a default specified component. The default specified component may be determined based on the DOM and may include, for example, a root element, a host component, or other component of the GUI that contains numerous components. The default specified component may, in some cases, be the first component appearing in the DOM. In some embodiments, when the default specified component is determined, every component of the GUI may be identified as an associated component of the default specified component. As such, when no component is selected, a test case may be generated for every component of the GUI.

Being able to identify associated components based on the DOM is useful in understanding and testing components of a GUI. For example, identifying associated components based on the DOM may enable determination of structural relationships between the associated components and a parent component. These structural relationships may not be apparent based on a visual inspection of the GUI. Further, identifying associated components based on the DOM may obviate manual selection of each associated component, which may save time and/or computing resources while developing the GUI.

Once the associated components are identified, in block 606, properties of the specified component and the associated components identified in block 604 may be determined based on the DOM. For example, portions of the DOM corresponding to each of the specified component and the associated components may be parsed to determine aspects of the specified component and associated components, such as component names, component identifiers, component types, data types, inputs, response types, and so on.

In block 608, test cases for the specified component and the associated components are generated. The test cases may include, for example, steps that validate a behavior or presentation of a component, tips to complete the test case, and other relevant information that may assist in testing and/or understanding the component. As described herein, test case structures of a test case database and/or one or more ML models may be used to generate the test cases.

For example, a header component type may be determined for a component based on the DOM, and a corresponding test case structure for header components may be selected from a test case database accordingly. The test case generation tool may combine the selected test case structure and properties in the portion of the DOM corresponding to the component to form one or more steps of a test case for the first component. In another example, for each test case, the DOM or the portion of the DOM may be provided to one or more ML models, and the one or more ML models may provide, as output, the test case structure of one or more steps of the test case. In any case, one or more test cases, each containing one or more steps and/or relevant information, may be generated for each of the specified component and the component determined to be associated with the specified component. Being able to automatically (e.g., without user intervention) generate test cases allows for efficient and thorough testing of a GUI. Specifically, automatically generating test cases based on a DOM allows for the consideration of test cases that may otherwise be omitted from testing. Further, automatically generating results in fewer testing iterations, saving computational (e.g., processing and storage) costs.

In block 610, the process 600 may provide instructions to update a GUI to include the test cases generated in block 608. For example, a client instance may send the instructions to a client device to update a GUI displayed by the client device, as illustrated in FIG. 4. The instructions to update the GUI may also include instructions to display corresponding component names and component identifiers along with the test cases, as illustrated in FIGS. 6 and 7. Further, the instructions to update the GUI may include instructions to display a code coverage indication, as illustrated in FIG. 6. The test cases, the component names, the component identifiers, and/or the code coverage indication may be displayed in a workspace that displays the GUI, such as a GUI generation tool, such that the GUI under test and the updates may be displayed and viewed simultaneously.

Various embodiments disclosed herein are directed to techniques for generating and displaying test cases that may be performed for one or more selected components of a GUI. A GUI test case generation tool may identify any associated components (e.g., child components) of the selected components based on a Document Object Model (DOM) of the GUI and may generate and display test cases for the selected components and additional components. Specifically, the GUI test case generation tool may analyze a DOM of the GUI to determine aspects of the selected components and associated components, such as component types (e.g., headers, charts), data types (e.g., integers, characters), inputs (e.g., entry fields), response types (e.g., on-click functionalities), and default contents to be displayed.

Based on the aspects of the selected components and/or child components present in the DOM, the GUI test case generation tool may generate and display a name of the selected components and child components, an identification of the selected components and child components, and one or more test cases for each of the selected components and child components. In some embodiments, the GUI test case generation tool may use a database or library of test case structures and/or a machine learning model trained on prior DOMs and/or test case data to analyze the DOM and generate and display test cases. The test cases may include steps that validate a behavior or presentation of a component, tips to complete the test case, and other relevant notes that may assist in testing or understanding the component. For example, a test case for a chart component may include instructions to validate the name of the chart, a note that the amount of data points in the chart is undefined, and a data schema of the chart (e.g., “data ID, data 0, x, timestamp, y, value y”).

The GUI test case generation tool may be part of or used in conjunction with a GUI generation tool that facilitates development of the GUI. For example, the GUI test case generation tool may be a tab, menu, plugin or the like included with the GUI generation tool, such that the GUI under test and the displayed test cases may be displayed simultaneously. This may allow for a more efficient testing process, as GUI components may be iteratively debugged and implemented from a single workspace or window. For example, components of a GUI may be selected by a drag-and-click operation and/or test case generation may be initiated based on input to a button. A workspace of the GUI test case generation tool may also include buttons, tabs, and the like that may facilitate input for additional functionalities, such as calculating and displaying a code coverage value based on GUI components and test cases. Previously, test cases were manually developed for each component of a GUI in an error-prone, time-consuming, and/or computational expensive process. Identifying associated components and determining properties of the components based on the DOM allows for associated components to be intuitively and efficiently identified. Automatically generating test cases for components based on the DOM allows for comprehensive testing of the components, as properties of the components present in the DOM may be properly accounted for in generated test cases. As such, the techniques herein provide improved performance in testing components of a GUI and, accordingly, better-performing GUIs.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving a request to generate one or more test cases associated with a graphical user interface (GUI), wherein the request specifies a component of the GUI;
determining, based on a document object model (DOM) associated with the GUI, one or more properties associated with the component and additional components of the GUI;
generating, based on the one or more properties, one or more test cases for the component and for each of the additional components; and
providing instructions to update the GUI, wherein the instructions cause the GUI to indicate the one or more test cases.

2. The method of claim 1, wherein the request is received from a client device capable of displaying the GUI, and wherein the instructions to update the GUI are provided to the client device to cause the client device to update the GUI.

3. The method of claim 1, comprising:
identifying the additional components based on the request and the DOM.

4. The method of claim 1, wherein providing the instructions to update the GUI comprises:
transmitting data indicative of an updated GUI including the GUI and the one or more test cases.

5. The method of claim 1, wherein each test case of the one or more test cases comprises one or more steps to complete a test procedure of the specified component or an additional component of the additional components.

6. The method of claim 1, comprising:
causing display, by a client device, of the one or more properties associated with the specified component and each additional component of the additional components based on the DOM, wherein the one or more properties are usable to assist in completing a test procedure of the specified component or an additional component of the additional components.

7. The method of claim 1, wherein the one or more properties comprise a component type, a data type, an input, or a combination thereof.

8. The method of claim 1 comprising:
determining, based on the DOM, a total quantity of components included as part of the GUI;
determining a code coverage value based on the one or more test cases and the total quantity of components included as part of the GUI; and
providing the instructions to update the GUI, wherein the instructions cause the GUI to indicate the code coverage value.

9. The method of claim 1, wherein generating one or more test cases for the specified component and each additional component of the additional components based on the one or more properties comprises:
identifying respective display data and a respective component type for each of the specified component and the additional components based on the one or more properties;
determining a respective test case structure for each of the specified component and the additional components based on the respective component type of each of the specified component and the additional components, wherein each respective test case structure comprises an instruction associated with the respective component type and one or more input fields; and
replacing the one or more input fields of each respective test case structure with the respective display data to form the one or more test cases.

10. The method of claim 1, comprising:
determining respective identifiers associated with the specified component and each additional component of the additional components based on the DOM, wherein the instructions to update the GUI cause the GUI to indicate the respective identifiers.

11. A system, comprising:
processing circuitry; and
a memory, accessible by the processing circuitry, and storing instructions that, when executed by the processing circuitry, cause the processing circuitry to perform operations comprising:
receiving a request to generate one or more test cases, wherein the request specifies a component of a graphical user interface (GUI);
identifying one or more additional components associated with the component based on the request and a document object model (DOM) associated with the GUI;
determining one or more properties associated with the specified component and each additional component of the one or more additional components based on the DOM;
determining respective test case structures for the specified component and each additional component based on the one or more properties and a mapping of component types to test case structures;
generating one or more test cases for the component and each additional component of the one or more additional components based on the one or more properties and the respective test case structures; and
providing instructions to update the GUI, wherein the instructions cause the GUI to indicate the one or more test cases.

12. The system of claim 11, wherein the one or more properties comprises a respective component type of each of the specified component and each additional component.

13. The system of claim 12, wherein the respective component type comprises a button, a text field, or an image.

14. The system of claim 13, wherein the mapping of component types to test case structures is stored in a database accessible by the processing circuitry.

15. The system of claim 12, wherein generating the one or more test cases comprises:
providing, as input, the respective component types to a machine learning (ML) model trained on previously tested DOMs;
receiving, from the ML model, one or more natural language outputs comprising respective test case structures; and
generating the one or more test cases based on the one or more properties and the respective test case structures.

16. A non-transitory, computer readable medium comprising instructions that, when executed by processing circuitry, cause the processing circuitry to perform operations comprising:
receiving a request to generate one or more test cases, wherein the request specifies a component of a graphical user interface (GUI);
identifying one or more additional components associated with the component based on the request and a document object model (DOM) associated with the GUI;
determining respective display data and a respective component type associated with the specified component and each additional component of the one or more additional components based on the DOM;
determining a respective test case structure for each of the specified component and the one or more additional components based on the respective component type of each of the specified component and the one or more additional components, wherein each respective test case structure comprises an instruction associated with the respective component type;
combining each respective test case structure with the respective display data to form one or more test cases for the component and each additional component of the one or more additional components; and
providing instructions to update the GUI, wherein the instructions cause the GUI to indicate the one or more test cases.

17. The non-transitory, computer readable medium of claim 16, wherein the operations comprise:
determining respective identifiers associated with the specified component and each additional component of the one or more additional components based on the DOM, wherein the instructions to update the GUI cause the GUI to indicate the respective identifiers.

18. The non-transitory, computer readable medium of claim 16, wherein the instructions to update the GUI cause the GUI to indicate each respective identifier of the respective identifiers adjacent to a corresponding test case of the one or more test cases.

19. The non-transitory, computer readable medium of claim 16, wherein a respective display data of the specified component or an additional component of the one or more additional components comprises an input response behavior.

20. The non-transitory, computer readable medium of claim 16, wherein the instructions cause the GUI to indicate the display data differently from the test case structure.
